(19) United States
(12) Patent Application Publication
(10) Pub. No.: US 2018/0114286 A1
(43) Pub. Date: Apr. 26, 2018

(54) INTERACTIVE TIMER WITH LOCAL AND REMOTE SYSTEM INTEGRATION

(71) Applicant: NTN Buzztime, Inc., Carlsbad, CA (US)

(72) Inventors: Shanon Prum, Poway, CA (US); Ram Krishnan, San Diego, CA (US); Andy Platter, Carlsbad, CA (US)

(21) Appl. No.: 15/333,013

(22) Filed: Oct. 24, 2016

(51) Int. Cl. G06Q 50/12; G08B 21/18; G06Q 20/20; G06Q 30/06; G06Q 30/02

(52) U.S. Cl. CPC G06Q 50/12; G08B 21/182; G06Q 20/202; H04L 67/12; G06Q 30/0234; G06Q 30/0235; G06Q 30/0635

(57) ABSTRACT

Various embodiments of apparatus, systems and methods for providing a timing system to ensure prompt service of customer orders are disclosed. A timer tracks a predetermined maximum service time to determine when customer orders are served beyond the predetermined maximum service time. If a customer order is served after the predetermined maximum service timer has expired, a credit is provided to the customer automatically.

### BACKGROUND

### I. Field of Use

The present application relates generally to the hospitality industry. More specifically, the present application relates to apparatus and methods for tracking order processing times in hospitality settings.

### II. Description of the Related Art

The hospitality industry, which encompasses restaurants, bars, nightclubs, among others, is highly competitive. Restaurants, for example, frequently run promotions in order to drive sales. One popular promotion provides customers a discount on their meals if their meals do not arrive within a certain time period from when an order is taken. For example, a restaurant may run a “10 minutes or it's free!” promotion, where if a customer's food is not delivered by wait staff within 10 minutes or ordering, the meal is free.

The example promotion, above, is simple for customers to understand, yet it may prove problematic to implement in a restaurant setting. For example, who is responsible for measuring the time from when an order is taken? How is the time tracked? How are disputes resolved in cases where the food arrives a few seconds after the promotion time period?

Another problem with such a promotion is that it is difficult for the wait staff to track multiple tables to ensure that food arrives on time. Presently, there is no way for a wait person to know how long he or she has to deliver a customer's food within the allotted time frame.

Finally, there is presently no way to track the performance of such a promotion, other than to manually pour over customer checks to see how many times a free meal was provided, or to have customized software developed to automatically track such giveaways.

It would be desirable to automate promotions where time is a factor in determining an outcome of a promotion.

### SUMMARY

The embodiments herein describe systems, devices, and methods for providing an interactive timing system. In one embodiment, a customer communication device is described, comprising a user interface for receiving a customer order from a customer, a communication interface to transmit and receive wireless communication signals, a memory for storing processor-executable instructions and a predetermined maximum service time, the predetermined maximum service time comprising a maximum permitted time to deliver the customer order from when the customer order was placed, a timer for tracking a service time, the service time comprising a time from when the customer order is placed to a time that the customer order is served to the customer, and a processor coupled to the user interface, memory and the communication interface, for executing the processor-executable instructions that cause server to receive, by the processor, the customer order via the user interface, in response to receiving the customer order, start the timer, in response to receiving the customer order, transmit the customer order to a point-of-sale server, determine, by the processor, when the timer has reached the predetermined maximum service time, and in response to the timer reaching the predetermined maximum service time, provide, by the processor, an indication to the point-of-sale server via the communication interface that the predetermined maximum service time has been reached, wherein the point-of-sale server applies a credit to the customer in response to receiving the indication.

In another embodiment, a method for providing an interactive timing system is described, comprising receiving, by a processor, a customer order via a user interface, in response to receiving the customer order, starting the timer by the processor, in response to receiving the customer order, transmitting, by the processor via a communication interface, the customer order to a point-of-sale server, determining, by the processor, when the timer has reached a predetermined maximum service time, the predetermined maximum service time comprising a maximum permitted time to deliver the customer order from when the customer order was placed, and in response to the timer reaching the predetermined maximum service time, providing, by the processor, an indication to the point-of-sale server via the communication interface that the predetermined maximum service time has been reached, wherein the point-of-sale server applies a credit to the customer in response to receiving the indication.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a system for providing an interactive timing system in a restaurant setting;

FIG. 2 is a functional block diagram of one embodiment a server as shown in FIG. 1;

FIG. 3 is a functional block diagram of one embodiment of an order processing device as shown in FIG. 1;

FIG. 4 is a functional block diagram of one embodiment of customer communication device as shown in FIG. 1;

FIG. 5 is a flow diagram illustrating one embodiment of a method performed by the server as shown in FIG. 1 for providing an interactive timing system, in this example, in a restaurant setting where restaurant management has offered a promotion to its customers to receive a credit on their bill for any food item that is not served within ten minutes after ordering;

FIG. 6 is a flow diagram illustrating one embodiment of a method performed by the order processing device as shown in FIG. 1 for providing an interactive timing system, in this example, in a restaurant setting where restaurant management has offered a promotion to its customers to receive a credit on their bill for any food item that is not served within ten minutes after ordering; and

FIG. 7 is a flow diagram illustrating one embodiment of a method performed by the customer communication device as shown in FIG. 1 for providing an interactive timing system, in this example, in a restaurant setting where restaurant management has offered a promotion to its customers to receive a credit on their bill for any food item that is not served within ten minutes after ordering.

### DETAILED DESCRIPTION

The embodiments herein describe systems, methods and apparatus for providing an interactive timing system for use primarily in the hospitality industry, although the general concepts could be used in any other setting where goods or services are expected to be provided within a predetermined time period after ordering. Although the inventive concepts described are described herein as they relate to a restaurant setting, it should be understood that they may also be applied to other environments, such as pizza delivery, doctor waiting rooms, or any other setting where a good or a service is promised within a given time period.

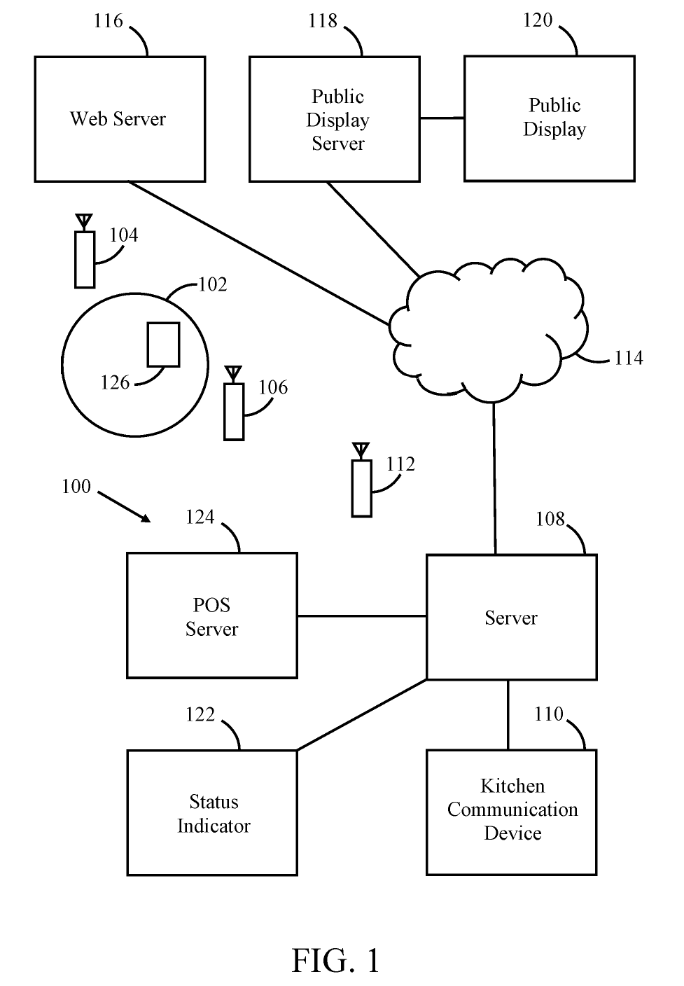

FIG. 1 illustrates one embodiment of a system 100 for providing an interactive timing system in a restaurant setting. Shown is table 102, customer communication device 104, order processing device 106, server 108, kitchen communication device 110, manager communication device 112, wide-area network 114, web server 116, public display server 118, public display 120, status indicator 122, POS server 124, timer/display 126. Each of kitchen communication device 110, manager communication device 112, order processing device 106, status indicator 122, and POS server 124 may be referred to herein as a “merchant communication device”. It should be understood that not all of the components shown in FIG. 1 are necessary for providing an interactive timing system. For example, status indicator 122 may not be used. Additionally, the manner in which each of the components communicates with other components may occur differently than as shown, using either wireless and/or wired communication technology well known in the art.

The restaurant may offer a promotion to its customers, providing a discount or even free food if their orders are not served to them within a predetermined time from when their orders are placed, herein referred to as a “predetermined maximum service time”. For example, the restaurant may run a promotion of “FIFTEEN OR ITS FREE”, where the restaurant will credit a customer with the price of an entrée if the entrée that was ordered is not served to the customer within 15 minutes after ordering. System 100 is used to track the “service time”, i.e., the elapsed time from when a customer order is placed, either by the customer or a waitperson, as described later herein, until the customer order is served. It may also provide status information to waitpersons and/or kitchen staff and/or management as the service time elapses. Statistical information may be compiled by server 108 as well, tracking waitperson performance by tallying, for example, how many times the predetermined maximum service time is exceeded by each waitperson.

A customer may enter the restaurant who is offering a timed promotion and be seated at table 102. A waitperson typically engages the customer, and may take a pre-entrée order, such as a beverage order. In another embodiment, the customer may order food and beverage items without use of a waitperson using customer communication device 104, as explained later herein. At some time later, the customer typically will order an entrée, such as a steak dinner with vegetables and mashed potatoes. The customer may additionally order one or more beverages.

In one embodiment, the waitperson uses order processing device 106 to record the customer's order. In one embodiment, the order may be transmitted to kitchen personal via order processing device 106 to kitchen communication device 110. A software application running on order processing device 106 may allow waitpersons to create a food and/or beverage order for an individual or for a number of individuals seated at table 102. Food and beverage orders may be added, deleted and modified using order processing device 106. In an embodiment where the orders are transmitted to kitchen communication device 110, kitchen communication device 110 received and displays the orders to kitchen personnel, who then prepare the orders. Kitchen communication device 110 comprise electronic circuitry for wirelessly receiving information from customer communication device 104, order processing device 106, and/or server 108, and a display for displaying customer's orders to the kitchen personnel. In one embodiment, a second kitchen communication device may located in a different part of the restaurant, such as at a bar, to receive and display non-food orders, such as alcoholic drink orders. In this embodiment, the software application may identify food items entered by the waitperson and transmit the food orders to kitchen communication device 110, while also automatically identifying beverage items and transmit beverage orders to the second kitchen communication device. In one embodiment, only alcoholic beverage orders are transmitted to the second kitchen communication device, as non-alcoholic beverages are typically prepared and served by the waitperson.

In another embodiment, the customer may order food and beverage items using customer communication device 104 without the aid of a waitperson. This kind of ordering directly by customers is becoming increasingly popular with restaurants as the general population becomes more and more familiar with modern smart phones and tablet computers. Customer communication device 104 is typically a wireless communication device owned by the customer, such as a cellular phone, smart phone, tablet computer, wearable device (such as a smart watch), or other portable, wireless communication device. In another embodiment, customer communication device 104 is provided to the customer, typically in the form of a tablet computer, by the restaurant when the customer is seated at table 102. In this embodiment, customer communication device 104 may be pre-loaded with specialized software that allows the customer to view and order food and beverage items from the restaurant, play games, play music, and otherwise interact with the restaurant and the goods and services that the restaurant provides to their customers. In yet another embodiment, customer communication device 104 may comprise dedicated hardware located at table 102, such as a proprietary device customized to present a menu of food and beverage items to the customer, to receive orders from the customer and transmit the orders to kitchen communication device 110 or some other device, such as order processing device 106 carried by a waitperson. In another embodiment, customer communication device 104 comprises a fixed computer or simply a user interface device, such as a keyboard, mouse and display, connected to server 108.

In any case, when the customer's order is transmitted by customer communication device 104 or order processing device 106, either device may start a timer (typically a software timer) to begin tracking the service time. In another embodiment, server 108 starts a timer to track the service time. If the order arrives at table 102 at or before expiration of the predetermined maximum service time, pre-defined by restaurant management, then the customer is charged the price of the order. However, if the customer's order has not been delivered to table 102 by the time the predetermined maximum service time has elapsed from when the order was placed, customer communication device 104 or order processing device 106 may apply a credit to the customer as provided by the promotion offered by restaurant management by sending the credit to either server 108, POS server 124, or both. In an embodiment where server 108 tracks the service time, the credit may be provided from server 108 to POS server 124. In another embodiment, server 108 provides an identification of one or more food or beverage items to be removed from the customer's bill to POS server 124.

Determination of when the order has been provided to the customer may be accomplished manually by a waitperson who delivers the customer's order to table 102. In this case, order processing device 106 may be used by the waitperson to press a button, icon or other input mechanism, indicating that the customer's order has been received. In one embodiment, order processing device 106, in turn, transmits an “order served” message to server 108, informing server 108 that the order was provided to the customer, and for server 108 to stop tracking the elapsed service time if the predetermined maximum service time has not been reached. In another embodiment, when the waitperson enters the order served into processing device 106, processing device 106 determines whether the order was served within the predetermined maximum service time. If not, order processing device 106 may transmit a credit to server 108 and/or POS server 124, instructing server 108 and/or POS sever 124 to provide a credit to the customer's bill.

In another embodiment, when the customer's order is served to the customer, the customer or the waitperson enters an indication into customer communication device 104, and customer communication device 104 determines whether the customer order was serviced within the predetermined maximum service time. If not, order customer communication device 104 may transmit a credit to server 108 and/or POS server 124, instructing server 108 and/or POS sever 124 to provide a credit to the customer's bill. In another embodiment, when the indication that the customer order was delivered is received by customer communication device 104, customer communication device 104 transmits a signal to server 108 and/or POS server 124 indicating such, and server 108 and/or POS serve 124 provides a credit to the customer.

During the service time, i.e., after a customer order is placed but before the order is served and before the predetermined maximum service time has elapsed, order processing device 106, customer communication device 104, and/or server 108 may provide status information of the customer order to one or more devices. For example, customer communication device 104 may provide a warning signal to one or more in-restaurant devices, such as manager communication device 112, when the elapsed service time reaches a warning time, the warning time defined as a predetermined time before the predetermined maximum service time is reached. The warning signal provides an indication to a waitperson, a manager, kitchen personnel, and/or the customer that the predetermined maximum service time is approaching so that action can be taken to attempt to service the customer order within the predetermined maximum service time. For example, when the warning signal is received by a waitperson, the waitperson can approach kitchen personnel to inquire about the order. Alternatively, or in addition, the warning signal may be provided to the kitchen personnel, such as a cook or chef, and the kitchen personnel can check on the order to check the status of the order and ensure that the order is prepared as quickly as possible to avoid exceeding the predetermined maximum service time. The manager communication device may comprise a smartphone, tablet computer, desktop computer, laptop computer, or any other device capable of receiving wireless messages from customer communication device 104, order processing device 106, and/or server 108, as known in the art.

In one embodiment, the warning message comprises additional information, such as an identification of the order (i.e., by order number, by a description of the order (i.e., ham and eggs”, etc.), a waitperson who took the order (by waitperson name, employee number, etc.), a table identification code where the order was taken (i.e., table number), all associated with the order that is nearing the predetermined maximum service time. This information is typically provided at the time the order is transmitted to server 108 and/or POS server 124. The application software running on order processing device 106 or customer communication device 104 may allow a waitperson or customer to enter such information as part of the order taking process, where it is stored and then transmitted along with the order, or in association with the order in a subsequent transmission.

Server 108 may, alternatively or in addition to the above, provide the warning message, or a separate warning signal, to status indicator 122. Status indicator 122 comprises an audio and/or visual output device, such as a speaker and/or a visual monitor, placed where, for example, both waitpersons and kitchen personnel may receive the warning signal from server 108. Status indicator 122 could, for example, comprise a number of LEDs arranged to provide an indication as to which orders are nearing the predetermined maximum service time, either by a table identification code, such as a table number, or by waitperson. Use a speaker allows the warning signal to audibly alert waitpersons, kitchen personnel and management of orders approaching the predetermined maximum service time.

Order processing device 104 or server 108 may additionally transmit an indication of the elapsed time since the order was taken (or the remaining time until the predetermined maximum service time is reached) to timer/display 126 and/or to customer communication device 104, to allow the customer to see, in real time, an elapsed time (or countdown of the predetermined maximum service time) after the customer order was placed. Timer/display 126 may comprise an LED display, a touch-screen device, a custom device configured displaying messages from the waitperson and/or kitchen personal pertaining to the customer's order, including the indication of the elapsed time. In one embodiment, timer/display 126 comprises the same functional components as customer communication device 104, allowing a customer to view menu items, place orders, view the elapsed time, etc.

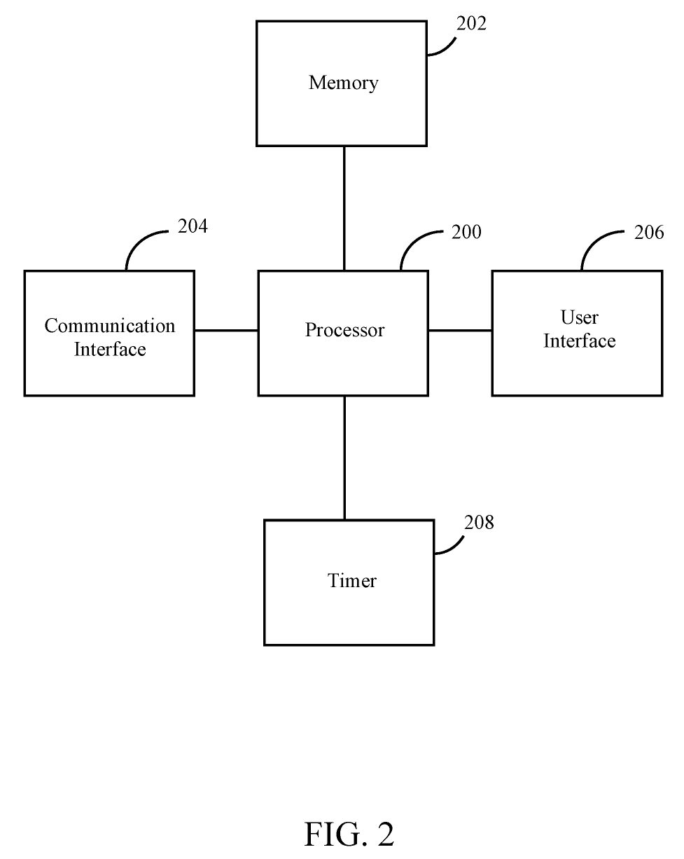

FIG. 2 is a functional block diagram of one embodiment of server 108. Specifically, FIG. 2 shows processor 200, memory 202, communication interface 204, user interface 206, and timer 208. It should be understood that not all of the functional blocks shown in FIG. 2 are required for operation of server 108 (for example, user interface may not be necessary), that the functional blocks may be connected to one another in a variety of ways, and that not all functional blocks necessary for operation of server 108 are shown (such as a power supply), for purposes of clarity.

Server 108 may comprise one of numerous commercially-available computer servers on the market today, including the P4300IP server system manufactured by Intel Corporation of Santa Clara, Calif. Processor 200 provides general operation of server 108 by executing processor-executable instructions stored in memory 202, for example, executable code. Processor 200 typically comprises a general purpose processor, such as any of the Xenon® family of processors manufactured by Intel Corporation of Santa Clara, Calif., although any one of a variety of microprocessors, microcomputers, and/or microcontrollers may be used alternatively.

Memory 202 comprises one or more information storage devices, such as hard drives, RAM memories, ROM memories, flash memories, and/or virtually any other type of electronic, optical, or mechanical memory device. Typically, memory 202 comprises more than one type of memory. For example, memory 202 may comprise a ROM memory used to store processor-executable instructions for operation of server 108, plus RAM memory to store customer account information. A variety of data may be stored in memory 202, such as the predetermined maximum service time, the warning time, historical data for each waitperson, such as how many times each waitperson has exceeded the predetermined maximum service time, etc.

Communication interface 204 is electronically coupled to processor 200 and comprises electronic circuitry necessary for server 108 to communicate with customer communication device 104, order processing device 106, kitchen communication device 110, web server 116, public display server 118, status indicator 122, POS server 124, and/or timer/display 126. Typically, communication interface 204 comprises hardware, software and/or firmware necessary to transmit and receive information sent via one or more commonly-used network protocols, such as the well-known TCP/IP suite of protocols. Alternatively, or in addition, communication interface 204 could comprise electronics and supporting software/firmware to support other well-known communication types, including Wi-Fi, Bluetooth, wireless telephone communications, fiber-optic communications, and so on. It should be understood that communication interface 204 could comprise circuitry to support multiple communication types, such as circuitry to support Wi-Fi, Ethernet, and RF technologies. This arrangement allows communication interface 204 to send and receive signals from customer communication device 104, order processing device 106, kitchen communication device 110, status indicator 122, and timer/display 126 via, for example, Wi-Fi and signals to/from web server 116, public display server 118 and POS server 124 via Ethernet.

User interface 206 is coupled to processor 200 and may be used to allow an individual to control operation of server 108 and/or to enter and receive information from server 108. User interface 206 may comprise one or more pushbuttons, switches, sensors, keypads, keyboards, touchscreens, and/or microphones that generate electronic signals for use by processor 200 upon initiation by a user. User interface 206 may additionally comprise one or more seven-segment displays, a cathode ray tube (CRT), a liquid crystal display (LCD), one or more light emitting diode displays (LEDD), one or more light emitting diodes (LEDs), light arrays, touchscreen devices, or any other type of visual display. Further, the electronic display could alternatively or in addition comprise an audio device, such as a speaker, for audible presentation of information to a user. Of course, the aforementioned items could be used alone or in combination with each other and other devices may be alternatively, or additionally, used.

Timer 208 comprises circuitry that tracks the elapsed time from when a customer order has been placed. Alternatively, it may be implemented as part of the processor-executable instructions stored in memory 202.

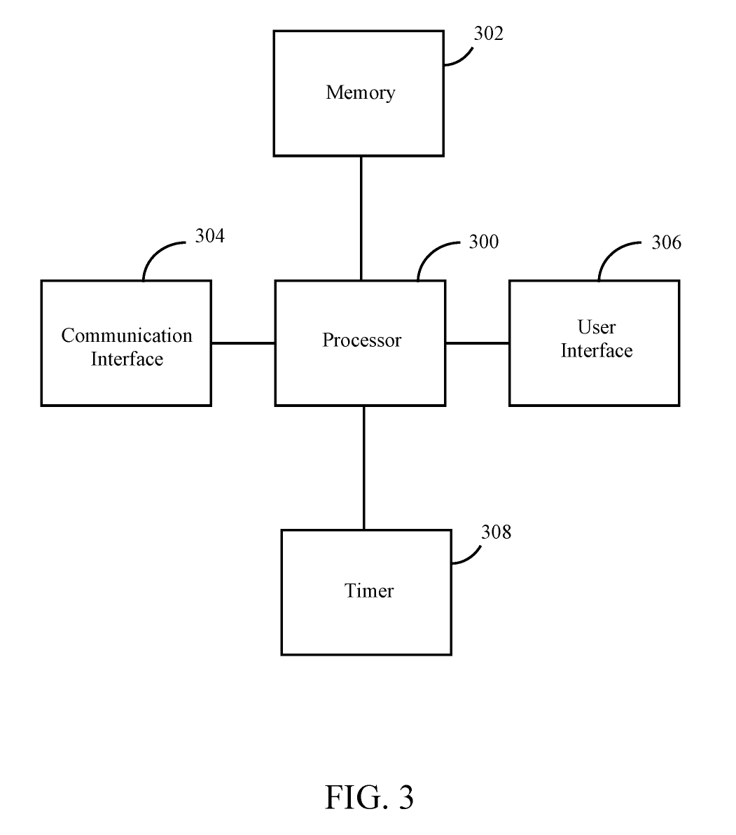

FIG. 3 is a functional block diagram of one embodiment of order processing device 106. Shown are processor 300, memory 302, communication interface 304, user interface 306, and timer 308. It should be understood that the functional blocks shown in FIG. 3 may be connected to one another in a variety of ways and that not all functional blocks necessary for operation of order processing device 106 are shown (such as a power supply), for purposes of clarity.

Processor 300 provides general operation of order processing device 106 by executing processor-executable instructions stored in memory 302, for example, executable code. Processor 300 typically comprises a general purpose processor, chosen to fit the form and power requirements of a portable electronic device, such as one of a number of microprocessors manufactured by Intel Corporation of Santa Clara, Calif., although any one of a variety of microprocessors, microcomputers, and/or microcontrollers sold by alternative manufacturers may be used alternatively.

Memory 302 comprises one or more information storage devices, such as hard drives, RAM memories, ROM memories, flash memories, and/or virtually any other type of electronic, optical, or mechanical memory device, suitable for a portable electronic device, i.e., comprise a small form-factor and require little power to operate. Typically, memory 302 comprises more than one type of memory. For example, memory 302 may comprise a ROM memory used to store processor-executable instructions for operation of order processing device 106, plus RAM memory to store customer orders, waitperson information, menus, the predetermined maximum service time, the warning time, etc.

Communication interface 304 is electronically coupled to processor 300 and comprises electronic circuitry necessary for order processing device 106 to communicate with customer communication device 104, server 108, kitchen communication device 110, web server 116, public display server 118, status indicator 122, POS server 124, and/or timer/display 126. Typically, communication interface 304 comprises hardware, software and/or firmware necessary to transmit and receive information sent via one or more commonly-used network protocols, such as the well-known TCP/IP suite of protocols. Alternatively, or in addition, communication interface 304 could comprise electronics and supporting software/firmware to support other well-known communication types, including Wi-Fi, Bluetooth, local wireless telephone communications, and so on. It should be understood that communication interface 304 could comprise circuitry to support multiple communication types, such as circuitry to support Wi-Fi and RF technologies.

User interface 306 is coupled to processor 300 and may be used to allow a waitperson or other restaurant personnel, to control operation of order processing device 106. User interface 306 may comprise one or more pushbuttons, switches, sensors, keypads, keyboards, touchscreens, and/or microphones that generate electronic signals for use by processor 300 upon initiation by a user. User interface 306 may additionally comprise one or more seven-segment displays, a cathode ray tube (CRT), a liquid crystal display (LCD), one or more light emitting diode displays (LEDD), one or more light emitting diodes (LEDs), light arrays, touchscreen devices, or any other type of visual display. Further, user interface 306 could alternatively or in addition comprise an audio device, such as a speaker, for audible reception and presentation of information to a user. Of course, the aforementioned items could be used alone or in combination with each other and other devices may be alternatively, or additionally, used.

Timer 308 comprises circuitry that tracks the elapsed time from when a customer order has been placed. Alternatively, it may be implemented as part of the processor-executable instructions stored in memory 302.

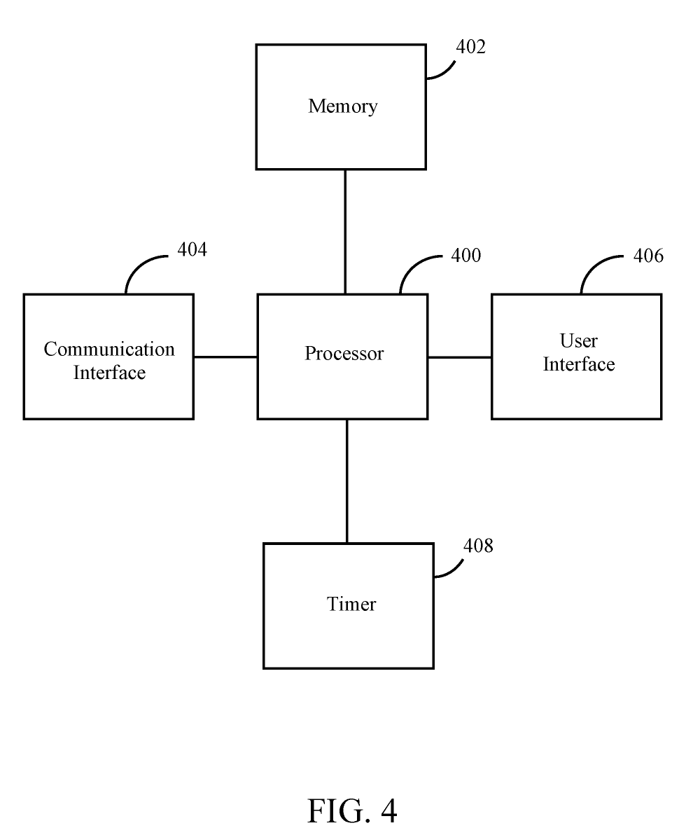

FIG. 4 is a functional block diagram of one embodiment of customer communication device 104. Shown are processor 400, memory 402, communication interface 404, user interface 406, and timer 408. It should be understood that the functional blocks shown in FIG. 4 may be connected to one another in a variety of ways and that not all functional blocks necessary for operation of customer communication device 104 are shown (such as a power supply), for purposes of clarity.

Processor 400 provides general operation of customer communication device 104 by executing processor-executable instructions stored in memory 402, for example, executable code. Processor 400 typically comprises a general purpose processor, chosen to fit the form and power requirements of a portable electronic device, such as one of a number of microprocessors manufactured by Intel Corporation of Santa Clara, Calif., although any one of a variety of microprocessors, microcomputers, and/or microcontrollers sold by alternative manufacturers may be used alternatively.

Memory 402 comprises one or more information storage devices, such as hard drives, RAM memories, ROM memories, flash memories, and/or virtually any other type of electronic, optical, or mechanical memory device, suitable for a portable electronic device, i.e., comprise a small form-factor and require little power to operate. Typically, memory 402 comprises more than one type of memory. For example, memory 402 may comprise a ROM memory used to store processor-executable instructions for operation of customer communication device 104, plus RAM memory to store customer orders, waitperson information, menus, the predetermined maximum service time, the warning time, etc.

Communication interface 404 is electronically coupled to processor 400 and comprises electronic circuitry necessary for customer communication device 104 to communicate with order processing device 106, server 108, kitchen communication device 110, web server 116, public display server 118, status indicator 122, POS server 124, and/or timer/display 126. Typically, communication interface 404 comprises hardware, software and/or firmware necessary to transmit and receive information sent via one or more commonly-used network protocols, such as the well-known TCP/IP suite of protocols. Alternatively, or in addition, communication interface 404 could comprise electronics and supporting software/firmware to support other well-known communication types, including Wi-Fi, Bluetooth, local wireless telephone communications, and so on. It should be understood that communication interface 304 could comprise circuitry to support multiple communication types, such as circuitry to support Wi-Fi and RF technologies.

User interface 406 is coupled to processor 400 and may be used to allow a customer to control operation of customer communication device 104. User interface 406 may comprise one or more pushbuttons, switches, sensors, keypads, keyboards, touchscreens, and/or microphones that generate electronic signals for use by processor 400 upon initiation by a customer. User interface 406 may additionally comprise one or more seven-segment displays, a cathode ray tube (CRT), a liquid crystal display (LCD), one or more light emitting diode displays (LEDD), one or more light emitting diodes (LEDs), light arrays, touchscreen devices, or any other type of visual display. Further, user interface 306 could alternatively or in addition comprise an audio device, such as a speaker, for audible reception and presentation of information to a customer. Of course, the aforementioned items could be used alone or in combination with each other and other devices may be alternatively, or additionally, used.

Timer 408 comprises circuitry that tracks the elapsed time from when a customer order has been placed. Alternatively, it may be implemented as part of the processor-executable instructions stored in memory 402.

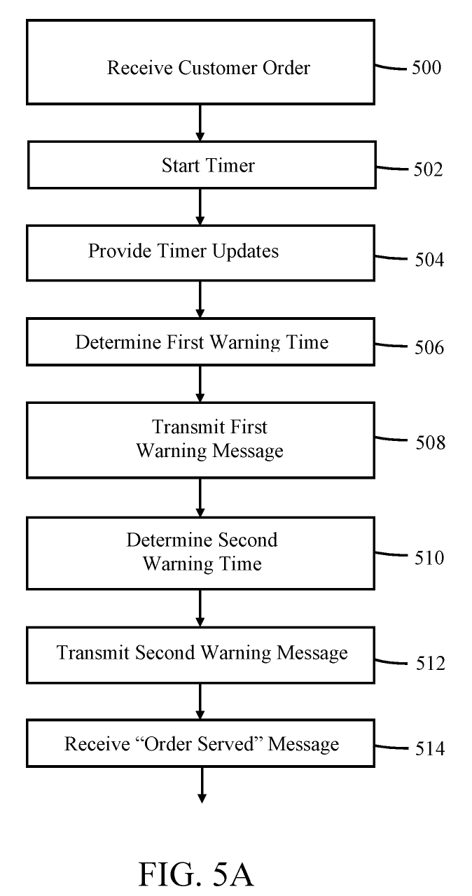

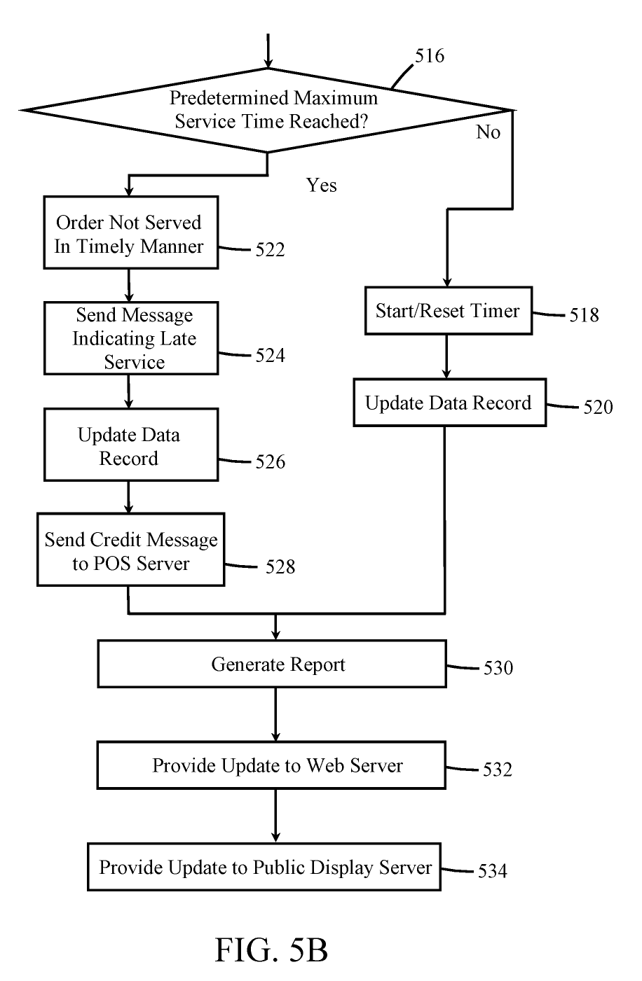

FIG. 5 is a flow diagram illustrating one embodiment of a method performed by server 108 for providing an interactive timing system, in this example, in a restaurant setting where restaurant management has offered a promotion to its customers to receive a credit on their bill for any food item that is not served within ten minutes after ordering. The credit may comprise the price of one or more food or beverage items in an order, or the entire order, taken from an individual customer or a group of customers. The credit may also comprise a coupon or discount for use in a customer's future visit to the restaurant. The method is implemented by processor 200 located within server 108, executing processor-executable instructions stored in memory 202. It should be understood that in some embodiments, not all of the steps shown in FIG. 5 are performed and that the order in which the steps are carried out may be different in other embodiments. It should be further understood that some minor method steps have been omitted for purposes of clarity.

At block 500, server 108 receives a customer order via communication interface 204, where it is provided to processor 200. The customer order may comprise a single food or beverage item for a single customer, multiple food and beverage items for a single customer, and/or multiple food and beverage items from a group of customers sitting at the same table. The customer order is sent by a customer using customer communication device 104 or by a waitperson using order processing device 106. The customer order comprises an identification of one or more food and/or beverage items selected by the customer. It may also comprise a table identification code which uniquely identifies the table and/or a waitperson identification code, which uniquely identifies the waitperson who is taking the customer's order. It may further comprise an order identification code which uniquely identifies the order. Still further, the customer order may comprise a customer bill identification number, which may be automatically generated by order processing device 106 and associated with the customer order. The order identification code may, alternatively, be generated by processor 200. This information may be stored in memory 202 in association with each other and the customer order. In one embodiment, the customer order comprises an indication that the order is a “timed” order, i.e., that it was ordered in association with the promotion offered by the restaurant.

At block 502, processor 200 begins a timer to track an elapsed time from when the customer order was placed or otherwise received by processor 200. In another embodiment, a timer is started at table 102 by customer communication device 104, order processing device 106, or timer/display 126 in response to the customer order being placed. Timer/display 126 comprises an electronic display for displaying the elapsed time from when a customer order is placed. It may also comprise circuitry to track the elapsed time and/or to receive wireless communication signals from other devices to provide the elapsed time or other updates.

At block 504, server 108 may provide one or more updates to the customer or the waitperson via communication interface 204 of the elapsed time or time remaining until the predetermined maximum service time expires. For example, either timer/display 126 could show the elapsed time/remaining time to the customer seated at table 102 as the elapsed time progresses. Alternatively, or in addition, server 108 could provide such elapsed time/remaining time to customer communication device 104, order processing device 106, kitchen communication device 110, manager communication device 112, and/or status indicator 122. The update(s) may comprise a single indication that an elapsed time has started, whereby the device receiving the update may use the elapsed start time and track the elapsed time locally, and display the elapsed time/remaining time to the customer in real time.

At block 506, server 108 may determine that the elapsed time has reached a predetermined time before reaching the predetermined maximum service time, such as 5 minutes, referred to herein as the “first warning time”. The first warning time is set to allow the waitperson, kitchen personnel and/or management enough time to correct any problems in serving the customer order within the predetermined maximum service time. Server 108 determines when the elapsed time has reached the first warning time by comparing the remaining time or the elapsed time to the first warning time stored in memory 202. Alternatively, in an embodiment where the elapsed time is tracked by a device other than server 108, server 108 may receive a signal from the other device, indicating that the first warning time has been reached.

At block 508, in response to reaching the first warning time, server 108 may provide a first warning message to one or more of customer communication device 104, order processing device 106, kitchen communication device 110, manager communication device 112, status indicator 122, and/or timer/display 126. The first warning message may provide information about the customer order, such as an associated table identification code, waitperson identification code, a description of the order, an order identification code, the remaining time until the predetermined maximum service time is reached, and or the elapsed time from when the order was placed. This information may be displayed to the waitperson, kitchen personnel, manager, and/or customer via order processing device 106, kitchen communication device 110, manager communication device 112, status indicator 122, and/or timer/display 126.

At block 510, server 108 may determine that the elapsed time has reached a second predetermined time before the predetermined maximum service time, such as 2 minutes, referred to herein as the “second warning time”. The second warning time is set to provide an urgent message to the waitperson, kitchen personnel and/or management that the predetermined maximum service time is fast approaching, so that the waitperson, kitchen personnel and/or management can focus their attention on a particular customer order whose elapsed time is very close to the predetermined maximum service time, so that an attempt can be made to serve the customer order to the customer before expiration of the predetermined maximum service time. Server 108 determines when the elapsed time has reached the second warning time by comparing the remaining time or the elapsed time to the second warning time stored in memory 202. Alternatively, in an embodiment where the elapsed time is tracked by a device other than server 108, server 108 may receive a signal from the other device, indicating that the second warning time has been reached.

At block 512, in response to reaching the second warning time, server 108 may provide a second warning message to one or more of order processing device 106, kitchen communication device 110, manager communication device 112, status indicator 122, and/or timer/display 126. The second warning message may provide information about the customer order, such as an associated table identification code, waitperson identification code, a description of the order, an order identification code, the remaining time until the predetermined maximum service time is reached, and or the elapsed time from when the order was placed. This information may be displayed to the waitperson, kitchen personnel, manager, and/or customer via order processing device 106, kitchen communication device 110, manager communication device 112, status indicator 122, and/or timer/display 126. The second warning message may be sent to different people than the first warning message. For example, the first warning message may be sent only to the waitperson, while the second warning message may be sent to the waitperson, kitchen personnel, and the manager.

At block 514, server 108 may receive an “order served” message from either customer communication device 104 or order processing device 106. The order served message is an indication that that the customer's order was served to the customer. In one embodiment, after the customer order is served to the customer, the waitperson uses order processing device 106 to enter an indication that the order was served, such as by pressing a dedicated key or soft key on the display of order processing device 106. In response, order processing device 106 sends the order served message to server 108. Similarly, the customer may use customer communication device 104 to enter an indication that the order was served, such as by pressing a dedicated key or soft key on the display of customer communication device 104. In response, customer communication device 104 sends the order served message to server 108.

At block 516, server 108 determines whether the predetermined maximum service time has been reached or exceeded by comparing the elapsed time (or remaining time) up until the order served message was received (or by evaluating a time stamp sent along with the order served message, indicating a time of transmission by order processing device 106 or customer communication device 104) with the predetermined maximum service time stored in memory 202. If the elapsed time is equal to or less than the predetermined maximum service time, this is an indication that the customer order was served to the customer in a timely manner, and no credit or discount is provide to the customer.

At block 518, server 108 may reset the timer and/or send a message to customer communication device 104, order processing device 106, kitchen communication device 110, manager communication device 112, status indicator 122, timer/display 126, and/or timer/display 126 indicating that the customer order was served to the customer in a timely manner. For example, the message may cause one or more of the above devices to display a message to the customer that the customer order was served within the predetermined maximum service time, provide the actual elapsed time that the customer order was served, and/or a description of the food and/or beverages that were served to the customer.

At block 520, server 108 may additionally update a data record in memory 202 associated with the waitperson who took the customer order, and update a number of times that the waitperson successfully served a customer order within the predetermined maximum service time. The elapsed time that the customer order was served may also be saved in memory 202, along with other information, such as the time that an order was placed, the table identification code, or some other information pertaining to the customer order.

At block 522, after the served order message is received at block 514, if the elapsed time is greater than the predetermined maximum service time, this is an indication that the customer order was not served to the customer in a timely manner.

At block 524, server 108 may send a message to order processing device 106, indicating that the customer order was not served to the customer within the predetermined maximum service time. Order processing device 106, in turn, may alert the waitperson by displaying a message indicating that the customer order was not served to the customer within the predetermined maximum service time, sounding an alert, causing order processing device 106 to vibrate, or a combination of these.

At block 526, server 108 may additionally update the data record in memory 202 associated with the waitperson who took the customer order, and update a number of times that the waitperson did not successfully serve a customer order within the predetermined maximum service time. The elapsed time that the customer order was served may also be saved in memory 202, along with, in one embodiment, an identification of the food and/or beverages that were provided within the predetermined maximum service time or other information pertaining to the customer order.

At block 528, server 108 may send a message to POS server 124 for POS server 124 to apply a credit or discount to the customer. The message may indicate a credit type (i.e., full credit of entrée to current bill, partial credit of entire bill, credit for a future visit to the restaurant, etc.), a dollar amount of the credit, an identification of the customer (such as a customer bill identification number), table identification code associated with the order, order number, and or an identification of the customer order or partial order (such as “steak dinner”, or “apple pie”). In one embodiment, the message instructs POS server 124 to remove one or more food or beverage items in the customer order. In response, POS server 124 credits the customer with a discount or credit, in one embodiment by reducing the customer's bill as tracked by POS server 124, either as provided by server 108, by a set of instructions stored in a memory of POS server 124, or in an amount specified in the message.

At block 530, whether the customer order was served to the customer on-time or not, server 108 may generate a report comprising the number of times that the maximum service time has been reached and/or exceeded over time associated with the waitperson. The report may be generated upon demand, for example from a manager or other restaurant management via a command sent to server 108 via communication interface 204, upon the number of times that the waitperson exceeded the predetermined maximum service time, as determined by comparing the waitperson's actual number of times that the waitperson exceeded the predetermined maximum service time with a threshold value stored in memory 202. The report is typically sent to a requesting manager communication device 112 and/or to some other device, such as a smart phone, tablet, computer, etc., operated by restaurant management. In another embodiment, user interface 206 is used by restaurant management to view the report.

At block 532, server 108 may provide an update to web server 116 with performance information pertaining to the restaurant in regard to the promotion. For example, server 108 may compute an average time that orders were served to customers based on the actual elapsed times stored in memory 202. Alternatively, or in addition, server 108 may compute a percentage of times that customer orders were served within the predetermined maximum service time. Web server 116 may comprise a social media web server, such as a server managed by Facebook, Twitter, Instagram, etc. When the information is received from server 108 in association with the restaurant performance, web server 116 may update the performance information in its records so that visitors to the restaurant's social media page will see up-to-date information pertaining to the speed and efficiency of the restaurant. The update may be provided to web server 116 upon demand from web server 116, at predetermined time intervals, upon the number of on-time/late service times exceeding predetermined thresholds, etc.

At block 534, server 108 may provide the performance information to some other remote server, such as public display server 118. Public display server 118 comprises a computer server that may provide information to public display 120, for example a billboard or an electronic sign, such as a sign outside of the restaurant or a display in Times Square. Public display server 118 may cause public display to display the performance information in a format that is easily understood by the public, such as in graphical or numerical form, to display the restaurant name, the restaurant promotion, and/or the number or percentage of times that customer orders were served within the predetermined maximum service time.

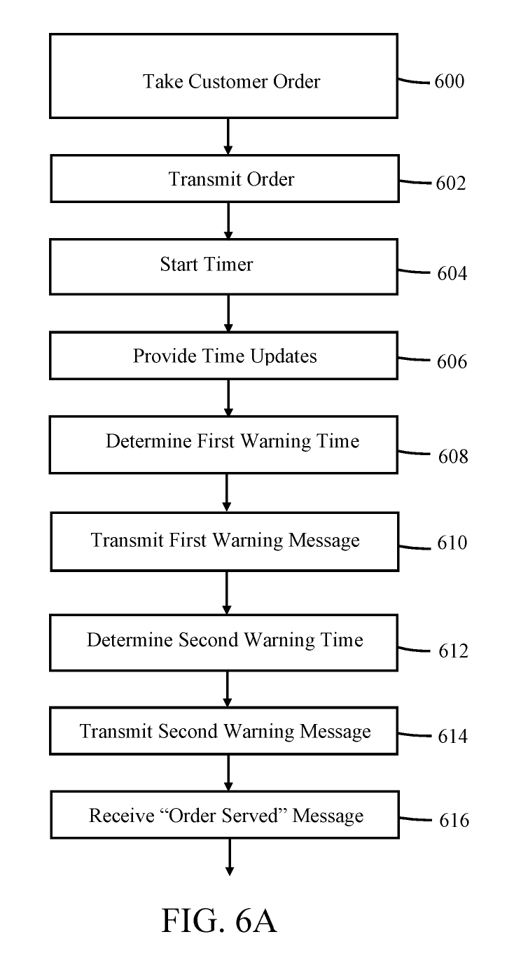

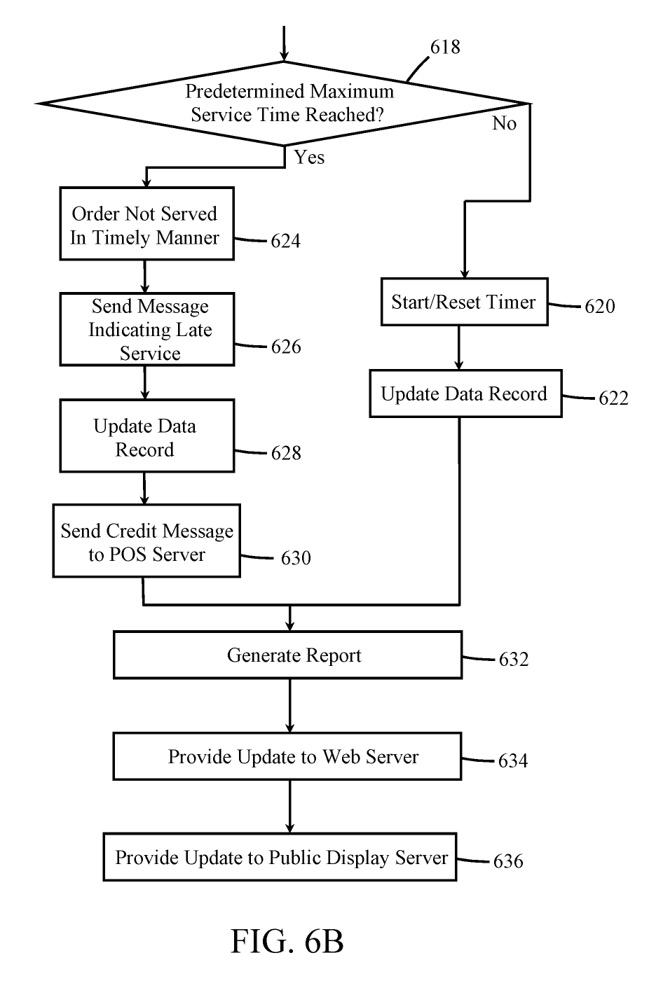

FIG. 6 is a flow diagram illustrating one embodiment of a method performed by order processing device 106 for providing an interactive timing system, in this example, in a restaurant setting where restaurant management has offered a promotion to its customers to receive a credit on their bill for any food item that is not served within ten minutes after ordering. The credit may comprise the price of one or more food or beverage items in an order, or the entire order, taken from an individual customer or a group of customers. The credit may also comprise a coupon or discount for use in a customer's future visit to the restaurant. The method is implemented by processor 300 located within order processing device 106, executing processor-executable instructions stored in memory 302. It should be understood that in some embodiments, not all of the steps shown in FIG. 6 are performed and that the order in which the steps are carried out may be different in other embodiments. It should be further understood that some minor method steps have been omitted for purposes of clarity.

At block 600, after a customer has been seated at a table, a waitperson takes the customer's order. The customer order may comprise a single food or beverage item for a single customer, multiple food and beverage items for a single customer, and/or multiple food and beverage items from a group of customers sitting at the same table. The waitperson enters the customer order via user interface 306. The customer order may include information other than the food and beverages ordered by the customer, such as a waitperson identification code, a table identification code, an order number, or other information associated with the customer order.

At block 602, processor 300 receives the customer order and other information and, in response, causes communication interface 304 to transmit the customer order and other information to POS server 124, server 108 and/or kitchen communication device 110. Transmission of the customer order and other information may be initiated by the waitperson entering a “send” command to processor 300 via user interface 306.

In one embodiment, when order processing device 106 transmits the customer order and other information to POS server 124, POS server 124 creates a “ticket”, “bill” or an account related to the customer order. For example, POS server 124 may itemize each food and beverage item that was included in the customer order, and associate each item with a price from a database accessible by POS server 124 or included in the customer order from order processing device 106. In one embodiment, POS server 124 also forwards the customer order to kitchen communication device 110 so that the kitchen personnel can begin preparing the customer order.

At block 604, proximate to the time that the customer order was transmitted at block 602, processor 300 starts timer 308, which may be implemented in software. The start of timer 308 initiates the service time, i.e., the time from when the customer order was placed until the customer order is served to the customer.

At block 606, processor 300 may provide one or more updates to other devices, via communication interface 304, such as customer communication device 104, server 108, manager communication device 112, status indicator 122, and/or kitchen communication device 110 via communication interface 304 of the elapsed time or time remaining until the predetermined maximum service time expires. For example, processor 300 may cause the elapsed service time, or time remaining until expiration of the predetermined maximum service time, to be transmitted as a stream or at predetermined time intervals, to kitchen communication device 110 to keep kitchen personnel apprised of the time remaining to prepare the customer order. The update(s) may comprise a single indication that an elapsed time has started, whereby the device receiving the update may use the elapsed start time and track the elapsed time locally, and display the elapsed time/remaining time to the customer in real time. The update may include the customer order number, waitperson identification code, table identification code, and/or other information related to the customer order.

At block 608, processor 300 may determine that the elapsed time has reached a predetermined time before reaching the predetermined maximum service time, such as 5 minutes, referred to herein as the “first warning time”. The first warning time is set to allow the waitperson, kitchen personnel and/or management enough time to correct any problems in serving the customer order within the predetermined maximum service time. Processor 300 determines when the elapsed time has reached the first warning time by comparing the remaining time or the elapsed time to the first warning time stored in memory 302. Alternatively, in an embodiment where the elapsed time is tracked by a device other than order processing device 106, processor 300 may receive a signal from the other device via communication interface 304, indicating that the first warning time has been reached.

At block 610, in response to reaching the first warning time, processor 300 may provide a first warning message to one or more of customer communication device 104, kitchen communication device 110, manager communication device 112, status indicator 122, and/or timer/display 126 via communication interface 304. The first warning message may also be provided by processor 300 to the waitperson via user interface 306, informing the waitperson that the first warning time has been reached. The first warning message may provide information about the customer order, such as an associated table identification code, waitperson identification code, a description of the order, an order identification code, the remaining time until the predetermined maximum service time is reached, and/or the elapsed time from when the order was placed.

At block 612, processor 300 may determine that the elapsed time has reached a second predetermined time before the predetermined maximum service time, such as 2 minutes, referred to herein as the “second warning time”. The second warning time is set to provide an urgent message to the waitperson, kitchen personnel and/or management that the predetermined maximum service time is fast approaching, so that the waitperson, kitchen personnel and/or management can focus their attention on a particular customer order whose elapsed time is very close to the predetermined maximum service time, so that an attempt can be made to serve the customer order to the customer before expiration of the predetermined maximum service time. Processor 300 determines when the elapsed time has reached the second warning time by comparing the remaining time or the elapsed time to the second warning time stored in memory 302. Alternatively, in an embodiment where the elapsed time is tracked by a device other than order processing device 106, processor 300 may receive a signal from the other device via communication interface 304, indicating that the second warning time has been reached.

At block 614, in response to reaching the second warning time, processor 300 may provide a second warning message to one or more of customer communication device 104, kitchen communication device 110, manager communication device 112, status indicator 122, and/or timer/display 126 via communication interface 304. The second warning message may also be provided by processor 300 to the waitperson via user interface 306, informing the waitperson that the second warning time has been reached. The second warning message may provide information about the customer order, such as an associated table identification code, waitperson identification code, a description of the order, an order identification code, the remaining time until the predetermined maximum service time is reached, and or the elapsed time from when the order was placed. The second warning message may be sent to different people than the first warning message, as before.

At block 616, processor 300 may receive an “order served” indication from user interface 306. The order served message is an indication that that the customer's order was served to the customer. In one embodiment, after the customer order is served to the customer, the waitperson enters an indication that the customer order was served via user interface 306, such as by pressing a dedicated key or soft key on the display of order processing device 106.

At block 618, processor 300 determines whether the predetermined maximum service time has been reached or exceeded by comparing the elapsed time (or remaining time) up until receipt of the order served indication with the predetermined maximum service time stored in memory 302. If the elapsed time is equal to or less than the predetermined maximum service time, this is an indication that the customer order was served to the customer in a timely manner, and no credit or discount is provide to the customer.

At block 620, processor 300 may reset timer 126 and/or send a message to customer communication device 104, order processing device 106, kitchen communication device 110, manager communication device 112, status indicator 122, timer 126, and/or timer/display 126 indicating that the customer order was served to the customer in a timely manner. In the case of sending the message to order processing device 106, processor 300 may provide an indication to user interface 306 indicating such. For example, the message may cause one or more of the above devices to display a message that the customer order was served within the predetermined maximum service time, provide the actual elapsed time that the customer order was served, an identification of the food and/or beverages that were provided within the predetermined maximum service time, etc.

At block 622, processor 300 may additionally update a data record in memory 302 associated with the waitperson who took the customer order, and update a number of times that the waitperson successfully served a customer order within the predetermined maximum service time. The elapsed time that the customer order was served may also be saved in memory 302, along with other information, such as the time that an order was placed, the table identification code, or some other information pertaining to the customer order. In another embodiment, processor 300 transmits a message to server 108 for updating a number of times that the waitperson successfully served a customer order within the predetermined maximum service time, as tracked by server 108.

At block 624, after the served order indication is received at block 616, if the elapsed time is greater than the predetermined maximum service time, this is an indication that the customer order was not served to the customer in a timely manner.

At block 626, processor 300 may send an indication to user interface 306, indicating that the customer order was not served to the customer within the predetermined maximum service time. Processor 300 may, alternatively or in addition, transmit a message to server 108 and/or customer communication device 104, indicating that the customer order was not served to the customer within the predetermined maximum service time, an identification of the food and/or beverages that were provided within the predetermined maximum service time, etc.

At block 628, processor 300 may update the data record in memory 302 associated with the waitperson who took the customer order, and update a number of times that the waitperson did not successfully serve a customer order within the predetermined maximum service time. The elapsed time that the customer order was served may also be saved in memory 202, and, in one embodiment, an identification of the food and/or beverages that were provided within the predetermined maximum service time, a time that the customer order was taken, and/or other information associated with the customer order.

At block 630, processor 300 may send a message to POS server 124 and/or server 108 for POS server 124 and/or server 108 to apply a credit or discount to the customer. The message may indicate a credit type (i.e., full credit of entrée to current bill, partial credit of entire bill, credit for a future visit to the restaurant, etc.), a dollar amount of the credit, an identification of the customer (such as a customer bill identification number), table identification code associated with the order, order number, and or an identification of the customer order or partial order (such as “steak dinner”, or “apple pie”). In one embodiment, the message instructs POS server 124 to remove one or more food or beverage items in the customer order. In response, POS server 124 or server 108 credits the customer with a discount or credit, in one embodiment by reducing the customer's bill as tracked by POS server 124, either as provided by server 108, by a set of instructions stored in a memory of POS server 124, or in an amount specified in the message.

At block 632, whether the customer order was on-time or late, processor 300 may generate a report comprising the number of times that the maximum service time has been reached and/or exceeded over time associated with the waitperson. The report may be generated upon demand, for example from a manager or other restaurant management via a command sent to order processing device 106 via communication interface 304, upon the number of times that the waitperson exceeded the predetermined maximum service time, as determined by comparing the waitperson's actual number of times that the waitperson exceeded the predetermined maximum service time with a threshold value stored in memory 302. The report may also or alternatively be generated by a user of order processing device 106 via user input 306. The report is typically sent to a requesting manager communication device 112, server 108 and/or to some other device, such as a smart phone, tablet, computer, etc., operated by restaurant management. In another embodiment, the report is provided to user interface 306 for viewing by a user of order processing device 106.

At block 634, processor 300 may provide an update to server 108 and/or web server 116 via communication interface 304 with performance information pertaining to the waitperson in regard to the promotion. For example, processor 300 may compute an average time that orders were served to customers based on the actual elapsed times stored in memory 302. Alternatively, or in addition, processor 300 may compute a percentage of times that customer orders were served within the predetermined maximum service time. Web server 116 may comprise a social media web server, such as a server managed by Facebook, Twitter, Instagram, etc. When the information is received from order processing device 106 in association with the waitperson performance, web server 116 may update the performance information in its records so that visitors to the restaurant's social media page will see up-to-date information pertaining to the speed and efficiency of the restaurant as a compilation of the waitperson's service times, as well as similar input from other waitpersons employed by the restaurant.

At block 636, processor 300 may provide the performance information to some other remote server, such as public display server 118. Public display server 118 comprises a computer server that may provide information to public display 120, for example a billboard or an electronic sign, such as a sign outside of the restaurant or a display in Times Square. Public display server 118 may cause public display to display the performance information of the waitperson in a format that is easily understood by the public, such as in graphical or numerical form, to display the restaurant name, the restaurant promotion, and/or the number or percentage of times that customer orders were served within the predetermined maximum service time.

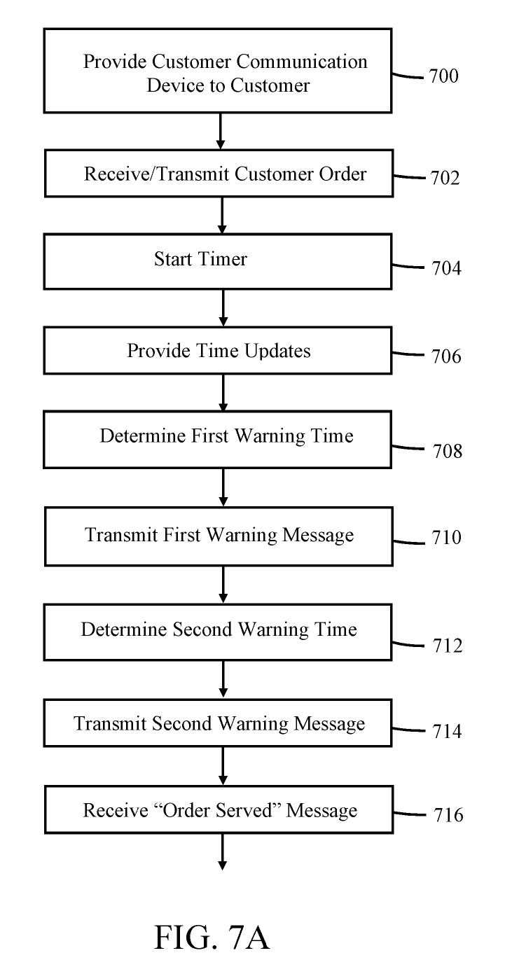

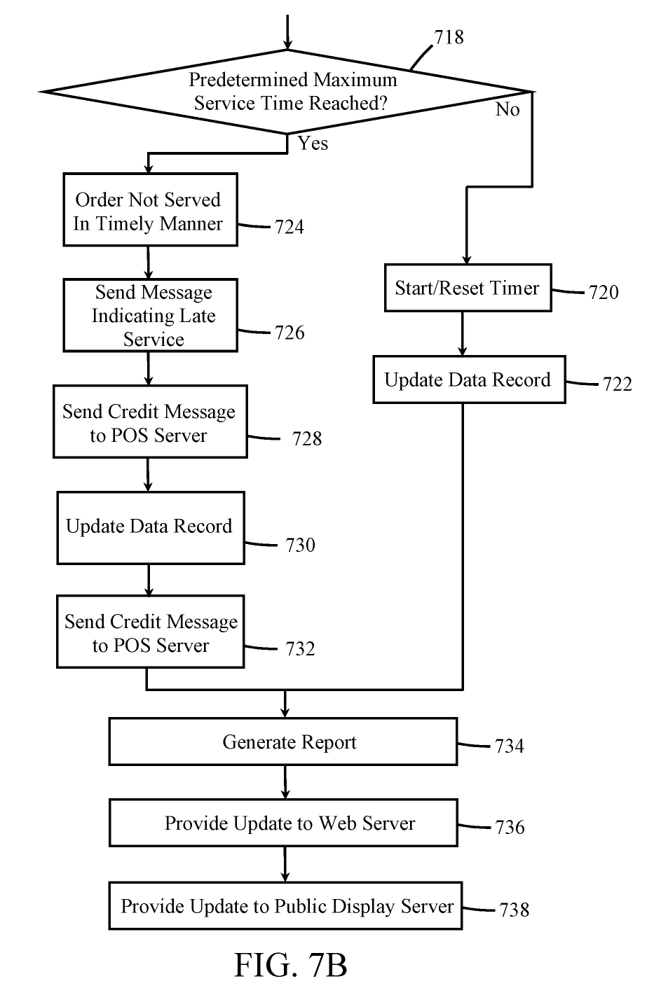

FIG. 7 is a flow diagram illustrating one embodiment of a method performed by customer communication device 106 for providing an interactive timing system, in this example, in a restaurant setting where restaurant management has offered a promotion to its customers to receive a credit on their bill for any food item that is not served within ten minutes after ordering. The credit may comprise the price of one or more food or beverage items in an order, or the entire order, taken from an individual customer or a group of customers. The credit may also comprise a coupon or discount for use in a customer's future visit to the restaurant. The method is implemented by processor 400 located within customer communication device 104, executing processor-executable instructions stored in memory 402. It should be understood that in some embodiments, not all of the steps shown in FIG. 7 are performed and that the order in which the steps are carried out may be different in other embodiments. It should be further understood that some minor method steps have been omitted for purposes of clarity.

At block 700, after a customer has been seated at a table, the customer may be given customer communication device 104, pre-loaded with a software application that allows the customer to place his or her own orders without involvement with a waitperson. In another embodiment, the customer may use his or her own mobile communication device, such as a smart phone or tablet computer, loaded with a similar software application that also allows the customer to place orders without the involvement of a waitperson. In either case, the software application may allow the customer to perform other actions as well, such as play music, play games, pay his or her bill, etc. In one embodiment, the software application additionally tracks the service time to determine if a customer order is served to the customer within the predetermined maximum service time.

The customer enters food and beverage orders into customer communication device 104 in response to menu items being displayed to the customer via user interface 406. The customer order may comprise a single food or beverage item for a single customer, multiple food and beverage items for a single customer, and/or multiple food and beverage items from a group of customers sitting at the same table. The customer order may include information other than the food and beverages ordered by the customer, such as a table identification code where the customer has been seated, an order number, or other information associated with the customer order.

At block 702, processor 400 receives the customer order and other information and, in response, causes communication interface 404 to transmit the customer order and other information to either POS server 124, server 108, order processing device 106, status indicator 122 and/or kitchen communication device 110. Transmission of the customer order and other information may be initiated by the customer entering a “send” command to processor 400 via user interface 406. In one embodiment, where the customer order and other information is provided to order processing device and/or status indicator 122, a food server may be assigned to serve the customer order after it has been prepared by kitchen personnel. A food server may carry a food server communication device similar to order processing device 106 for receiving customer orders. In another embodiment, server 108 assigns the customer order to food servers upon receipt of a new customer order depending on pre-programmed criteria, such as how many customer orders a particular food server is presently responsible for.

In one embodiment, when customer communication device 104 transmits the customer order and other information to POS server 124, POS server 124 creates a “ticket”, “bill” or accounting related to the customer order. For example, POS server 124 may itemize each food and beverage item that was included in the customer order, and associate each item with a price from a database accessible by POS server 124 or included in the customer order from customer communication device 104. In one embodiment, POS server 124 also forwards the customer order to kitchen communication device 110 so that the kitchen personnel can begin preparing the customer order.

At block 704, proximate to the time that the customer order was transmitted at block 702, processor 400 starts timer 408, which may be implemented in software, i.e. part of the processor-executable instructions stored in memory 402. The start of timer 408 initiates the service time, i.e., the time from when the customer order was placed until the customer order is served to the customer.

At block 706, processor 400 may provide one or more updates to other devices, via communication interface 404, such as order processing device 106, server 108, status indicator 122, manager communication device 112, and/or kitchen communication device 110 via communication interface 404 of the elapsed time or time remaining until the predetermined maximum service time expires. For example, processor 400 may cause the elapsed service time, or time remaining until expiration of the predetermined maximum service time, to be transmitted as a stream or at predetermined time intervals, to kitchen communication device 110 to keep kitchen personnel apprised of the time remaining to prepare the customer order. The update(s) may comprise a single indication that an elapsed time has started, whereby the device receiving the update may use the elapsed start time and track the elapsed time locally, and display the elapsed time/remaining time to the customer in real time. The update may include the customer order number, waitperson identification code, table identification code, and/or other information related to the customer order.

At block 708, processor 400 may determine that the elapsed time has reached a predetermined time before reaching the predetermined maximum service time, such as 5 minutes, referred to herein as the “first warning time”. The first warning time is set to allow the waitperson, kitchen personnel and/or management enough time to correct any problems in serving the customer order within the predetermined maximum service time. Processor 400 determines when the elapsed time has reached the first warning time by comparing the remaining time or the elapsed time to the first warning time stored in memory 402. Alternatively, in an embodiment where the elapsed time is tracked by a device other than order processing device 106, processor 400 may receive a signal from the other device via communication interface 404, indicating that the first warning time has been reached.

At block 710, in response to reaching the first warning time, processor 400 may provide a first warning message to one or more of order processing device 106, kitchen communication device 110, manager communication device 112, status indicator 122, and/or timer/display 126 via communication interface 404. The first warning message may also be provided by processor 400 to the customer via user interface 406, informing the customer that the first warning time has been reached. The first warning message may provide information about the customer order, such as an associated table identification code, a description of the order, an order identification code, the remaining time until the predetermined maximum service time is reached, and/or the elapsed time from when the order was placed.

At block 712, processor 400 may determine that the elapsed time has reached a second predetermined time before the predetermined maximum service time, such as 2 minutes, referred to herein as the “second warning time”. The second warning time is set to provide an urgent message to the waitperson/food server, kitchen personnel and/or management that the predetermined maximum service time is fast approaching, so that the waitperson, kitchen personnel and/or management can focus their attention on a particular customer order whose elapsed time is very close to the predetermined maximum service time, so that an attempt can be made to serve the customer order to the customer before expiration of the predetermined maximum service time. Processor 400 determines when the elapsed time has reached the second warning time by comparing the remaining time or the elapsed time to the second warning time stored in memory 402. Alternatively, in an embodiment where the elapsed time is tracked by a device other than customer communication device 104, processor 400 may receive a signal from the other device via communication interface 404, indicating that the second warning time has been reached.

At block 714, in response to reaching the second warning time, processor 400 may provide a second warning message to one or more of order processing device 106, kitchen communication device 110, manager communication device 112, status indicator 122, and/or timer/display 126 via communication interface 404. The second warning message may also be provided by processor 400 to the customer via user interface 406, informing the customer that the second warning time has been reached. The second warning message may provide information about the customer order, such as an associated table identification code, waitperson identification code, a description of the order, an order identification code, the remaining time until the predetermined maximum service time is reached, and or the elapsed time from when the order was placed. The second warning message may be sent to different people than the first warning message, as before.

At block 716, processor 400 may receive an “order served” indication from the customer via user interface 406. The order served message is an indication that that the customer's order was served to the customer. In one embodiment, after the customer order is served to the customer, the customer enters an indication that the customer order was served via user interface 406, such as by pressing a dedicated key or soft key on the display of customer communication device 104. In another embodiment, the waitperson/food server enters the order served indication using order processing device 106 after the waitperson/food server has served the customer order to the customer. In this embodiment, the order served indication comprises an order identification number associated with a particular order that has been served, wherein processor 300 within order processing device 106 receives the order served indication and order identification code via user interface 306 and then transmits the order served message via communication interface 304 to server 108, which associates the order identification code with a customer communication device that placed the order. Processor 400 then provides a notification to the particular customer communication device that an order served indication was received, so that the customer communication device stops the timer. In another embodiment, order processing device 106 transmits the order serviced indication directly to customer communication device 104. In yet another embodiment, an order served indication could be generated by kitchen communication device 110 when kitchen personnel provide an indication to kitchen communication device 110 that a customer order has been placed onto a pickup area or when an order is actually picked up by a waitperson or food runner.

At block 718, processor 400 determines whether the predetermined maximum service time has been reached or exceeded by comparing the elapsed time (or remaining time) up until receipt of the order served indication with the predetermined maximum service time stored in memory 402. If the elapsed time is equal to or less than the predetermined maximum service time, this is an indication that the customer order was served to the customer in a timely manner, and no credit or discount is provide to the customer.

At block 720, processor 400 may reset timer 408 and/or send a message to order processing device 106, kitchen communication device 110, manager communication device 112, status indicator 122, timer 126, and/or timer/display 126 indicating that the customer order was served to the customer in a timely manner. The message may also be displayed to the customer via user interface 406. For example, the message may cause one or more of the above devices to display a message that the customer order was served within the predetermined maximum service time, provide the actual elapsed time that the customer order was served, an identification of the food and/or beverages that were provided within the predetermined maximum service time, etc.

At block 722, processor 400 may additionally update a data record in memory 402 indicative of a number of times that customer orders were served within the predetermined maximum service time using a particular customer communication device 106. The elapsed time that the customer order was served may also be saved in memory 402, along with other information, such as the time that an order was placed, the table identification code, or some other information pertaining to the customer order. In another embodiment, processor 400 transmits a message to server 108 for updating a number of times that the customer order was served within the predetermined maximum service time, as tracked by server 108.

At block 724, after the served order indication is received at block 716, if the elapsed time is greater than the predetermined maximum service time, this is an indication that the customer order was not served to the customer in a timely manner.

At block 726, processor 400 may provide an indication to user interface 406, indicating that the customer order was not served to the customer within the predetermined maximum service time. Processor 400 may, alternatively or in addition, transmit a message, via communication interface 404, to order processing device 106, kitchen communication device 110, manager communication device 112, status indicator 122, and/or timer/display 126 indicating that the customer order was not served to the customer within the predetermined maximum service time, an identification of the food and/or beverages that were not provided within the predetermined maximum service time, an order number, etc.

At block 728, processor 400 sends a message to POS server 124 and/or server 108, indicating that the customer order was not served to the customer within the predetermined maximum service time, an identification of the food and/or beverages that were not provided within the predetermined maximum service time, an order number, etc.

At block 730, processor 400 may update a data record in memory 402 indicative of a number of times that customer orders were served within the predetermined maximum service time using a particular customer communication device 106. The elapsed time that the customer order was served may also be saved in memory 402, along with other information, such as the time that an order was placed, the table identification code, or some other information pertaining to the customer order. In another embodiment, processor 400 transmits a message to server 108 for updating a number of times that the customer order was served within the predetermined maximum service time, as tracked by server 108.

At block 732, processor 400 may send a message to POS server 124 and/or server 108 for POS server 124 and/or server 108 to apply a credit or discount to the customer as a result of the service time exceeding the predetermined maximum service time. The message may indicate a credit type (i.e., full credit of entrée to current bill, partial credit of entire bill, credit for a future visit to the restaurant, etc.), a dollar amount of the credit, an identification of the customer (such as a customer bill identification number), table identification code associated with the order, order number, and or an identification of the contents of the customer order or partial order (such as “steak dinner”, or “apple pie”). In one embodiment, the message instructs POS server 124 to remove one or more food or beverage items in the customer order. In response, POS server 124 or server 108 credits the customer with a discount or credit, in one embodiment by reducing the customer's bill as tracked by POS server 124 and/or server 108, either as provided by server 108, by a set of instructions stored in a memory of POS server 124, or in an amount specified in the message. In one embodiment either POS server 124 and/or server 108 maintains a database of current prices for each menu item offered by the restaurant, and the stored prices are used to determine the credit given to the customer.

At block 734, whether the customer order was served to the customer on-time or not, processor 400 may generate a report comprising the number of times that the maximum service time has been reached and/or exceeded over time using the particular customer communication device 106. The report may be generated upon demand, for example from a manager or other restaurant management over via communication interface 404, or autonomously by processor 400 determining that the number of times that the predetermined maximum service time exceeded the predetermined maximum service time exceeded a predetermined threshold stored in memory 402. The report may also or alternatively be generated by a user of customer communication device 104 via user input 406. The report is typically sent via communication interface 404 to a requesting manager communication device 112, server 108 and/or to some other device, such as a smart phone, tablet, computer, etc., operated by restaurant management. In another embodiment, the report is provided to user interface 406 for viewing by a user of customer communication device 104.

At block 736, processor 400 may provide an update to server 108 and/or web server 116 via communication interface 404 with performance information pertaining to the number of times customer orders were provided within the predetermined maximum service time. For example, processor 400 may compute an average time that orders were served to customers using the particular customer communication device 104 based on the actual elapsed times stored in memory 402. Alternatively, or in addition, processor 400 may compute a percentage of times that customer orders were served using the particular customer communication device 104 within the predetermined maximum service time. Web server 116 may comprise a social media web server, such as a server managed by Facebook, Twitter, Instagram, etc. When the performance information is received from customer communication device 104, web server 116 may update the performance information in its records so that visitors to the restaurant's social media page will see up-to-date information pertaining to the speed and efficiency of the restaurant as a compilation of the performance information provided by customer communication device 104 and other customer communication devices used by the restaurant.

At block 738, processor 400 may provide the performance information to some other remote server, such as public display server 118. Public display server 118 comprise a computer server that may provide information to public display 120, for example a billboard or an electronic sign, such as a sign outside of the restaurant or a display in Times Square. Public display server 118 may cause public display to display the performance information of the waitperson in a format that is easily understood by the public, such as in graphical or numerical form, to display the restaurant name, the restaurant promotion, and/or the number or percentage of times that customer orders were served within the predetermined maximum service time.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A customer communication device for providing an interactive timing system, comprising:
a user interface for receiving a customer order from a customer;
a communication interface to transmit and receive wireless communication signals;
a memory for storing processor-executable instructions and a predetermined maximum service time, the predetermined maximum service time comprising a maximum permitted time to deliver the customer order from when the customer order was placed;
a timer for tracking a service time, the service time comprising a time from when the customer order is placed to a time that the customer order is served to the customer; and
a processor coupled to the user interface, memory and the communication interface, for executing the processor-executable instructions that cause server to:
receive, by the processor, the customer order via the user interface;
in response to receiving the customer order, start the timer;
in response to receiving the customer order, transmit the customer order to a point-of-sale server;
determine, by the processor, when the timer has reached the predetermined maximum service time; and
in response to the timer reaching the predetermined maximum service time, provide, by the processor, an indication to the point-of-sale server via the communication interface that the predetermined maximum service time has been reached;
wherein the point-of-sale server applies a credit to the customer in response to receiving the indication.

2. The customer communication device of claim 1, wherein the processor-executable instructions comprise further instructions that cause the customer communication device to:
determine, by the processor, when the timer has reached a warning time, the warning time a predetermined time before the predetermined maximum service time;
generate, by the processor, a warning signal as a result of the timer reaching the warning time; and
provide, by the processor, the warning signal to the communication interface for transmission to a merchant communication device for identification by merchant personnel of a table associated with the warning.

3. The customer communication device of claim 1, wherein the processor-executable instructions comprise further instructions that cause the customer communication device to:
determine, by the processor, an actual service time that the customer order was provided to the customer based on a time that the customer order was transmitted and the time that the customer order was served to the customer;
compare, by the processor, the actual service time to the predetermined maximum service time stored in memory; and
cancel the timer when the actual service time is less than the predetermined maximum service time.

4. The customer communication device of claim 1, wherein the processor-executable instructions comprise further instructions that cause the customer communication device to:
in response to providing the indication that the predetermined maximum service time has been reached, generate, by the processor, the credit based on the customer order; and
transmit an indication of the credit to a point-of-sale server for the point-of-sale server to apply the credit to an account associated with the customer.

5. The customer communication device of claim 2, wherein the processor-executable instructions comprise further instructions that cause the customer communication device to:
receive, by the processor via the user interface, a table identification code, the table identification code identifying a table where the customer communication device is located; and
store the table identification code in the memory;
wherein the warning signal comprises the table identification code for identification by merchant personnel of a table associated with the warning.

6. The customer communication device of claim 1, wherein the processor-executable instructions comprise further instructions that cause the customer communication device to:
determine a number of times that the maximum service time has been reached over time;
generate a report comprising the number of times that the maximum service time has been reached over time associated with the waitperson; and
provide the report to a merchant communication device.

7. The customer communication device of claim 6, wherein the processor-executable instructions that cause the server to generate the report comprise instructions that cause the customer communication device to:
generate the report when the number of times that the maximum service time has been reached associated with the waitperson identification code exceeds a predetermined threshold.

8. The customer communication device of claim 2, wherein the merchant communication device comprises a kitchen communication device that provides the customer order to kitchen personal.

9. The customer communication device of claim 8, wherein the processor-executable instructions comprise further instructions that cause the customer communication device to:
store the customer order in the memory;
provide the customer order, in association with the warning, to the kitchen communication device.

10. The customer communication device of claim 1, wherein the processor-executable instructions comprise further instructions that cause the customer communication device to:
transmit, by the processor via the communication interface, an indication of the predetermined maximum service time to a web server;
wherein the web server receives other indications from other customer communication devices to provide a total number of times that the predetermined maximum service time has been reached.

11. A method performed by a customer communication device for providing an interactive timing system, comprising:
receiving, by a processor, a customer order via a user interface;
in response to receiving the customer order, starting the timer by the processor;
in response to receiving the customer order, transmitting, by the processor via a communication interface, the customer order to a point-of-sale server;
determining, by the processor, when the timer has reached a predetermined maximum service time, the predetermined maximum service time comprising a maximum permitted time to deliver the customer order from when the customer order was placed; and
in response to the timer reaching the predetermined maximum service time, providing, by the processor, an indication to the point-of-sale server via the communication interface that the predetermined maximum service time has been reached;
wherein the point-of-sale server applies a credit to the customer in response to receiving the indication.

12. The method of claim 11, further comprising:
determining, by the processor, when the timer has reached a warning time, the warning time a predetermined time before the predetermined maximum service time;
generating, by the processor, a warning signal as a result of the timer reaching the warning time; and
providing, by the processor, the warning signal to the communication interface for transmission to a merchant communication device.

13. The method of claim 11, further comprising:
determining, by the processor, an actual service time that the customer order was provided to the customer based on a time that the customer order was transmitted and the time that the customer order was served to the customer;
comparing, by the processor, the actual service time to the predetermined maximum service time stored in memory; and
cancelling the timer when the actual service time is less than the predetermined maximum service time.

14. The method of claim 11, further comprising:
in response to providing the indication that the predetermined maximum service time has been reached, generating, by the processor, the credit based on the customer order; and
transmitting, by the processor via the communication interface, an indication of the credit to a point-of-sale server for the point-of-sale server to apply the credit to an account associated with the customer.

15. The method of claim 12, further comprising:
receiving, by the processor via the user interface, a table identification code, the table identification code identifying a table where the customer communication device is located; and
storing the table identification code in the memory;
wherein the warning signal comprises the table identification code for identification by merchant personnel of a table associated with the warning.

16. The method of claim 11, further comprising:
determining a number of times that the maximum service time has been reached over time;
generating a report comprising the number of times that the maximum service time has been reached over time associated with the waitperson; and
providing the report to a merchant communication device.

17. The method of claim 16, further comprising:
generating the report when the number of times that the maximum service time has been reached associated with the waitperson identification code exceeds a predetermined threshold.

18. The method of claim 12, wherein the merchant communication device comprises a kitchen communication device that provides the customer order to kitchen personal.

19. The method of claim 18, further comprising:
storing the customer order in the memory;
providing the customer order, in association with the warning, to the kitchen communication device.

20. The method of claim 11, further comprising:
transmitting, by the processor via the communication interface, an indication of the predetermined maximum service time to a web server;
wherein the web server receives other indications from other customer communication devices to provide a total number of times that the predetermined maximum service time has been reached.
